(19) United States
(12) Patent Application Publication
(10) Pub. No.: US 2022/0198302 A1
(43) Pub. Date: Jun. 23, 2022

(54) DESTINATION PREDICTION DEVICE, METHOD, AND PROGRAM

(71) Applicant: NIPPON TELEGRAPH AND TELEPHONE CORPORATION, Tokyo (JP)

(72) Inventors: Takuya NISHIMURA, Tokyo (JP); Yasunori AKAGI, Tokyo (JP); Takeshi KURASHIMA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/431,084

(22) PCT Filed: Feb. 3, 2020
(86) PCT No.: PCT/JP2020/003882

§ 371 Date: Aug. 13, 2021

(30) Foreign Application Priority Data
Feb. 15, 2019 (JP) 2019-025506

(51) Int. Cl. G06N 5/04

(52) U.S. Cl. CPC G06N 5/04

(57) ABSTRACT

A destination of a user is predicted with high accuracy while the user is moving regardless of whether past movement trajectory data of the user does not exist or the past movement trajectory data of the user exists. A destination prediction device according to the present disclosure includes: a first destination prediction unit that predicts a destination candidate of the user who is moving and a value that represents certainty of the destination candidate on the basis of the movement trajectory data that represents a movement trajectory of the user to the present point and movement history data of the user in the past; a second destination prediction unit that predicts a destination candidate of the user and a value that represents the certainty of the destination candidate on the basis of the movement trajectory data of the user and data that represents a movement tendency set in accordance with movement states of people; and an ensemble prediction unit that predicts a destination and a value that represents the certainty of the destination by combining the destination candidates and the values that represent the certainty of the destination candidates predicted by the first destination prediction unit and the second destination prediction unit.

### TECHNICAL FIELD

The present disclosure relates to destination prediction device, method, and program.

### BACKGROUND ART

It has been a common practice to collect movement trajectory data with the spread of smart devices including a global positioning system (GPS) function, for example. The movement trajectory data is a set of positioning points defined as a three-piece set of time, latitude, and longitude. There is a need for estimating a destination of a moving user by using the movement trajectory data. The destination estimation may provide for services such as presenting information about the periphery of the destination before the user arrives at the destination.

In a destination prediction method of related techniques, the past movement trajectory of the user is learned in advance, and by using the result of the learning, the place to which the user will move with a high probability is estimated in accordance with the current movement trajectory. For example, there are following techniques. In a technique (Non-Patent Literature 1), on the basis of a past movement trajectory of a user who is subjected to estimation, movement probability between adjacent grids sectioning a space is estimated, and a destination is predicted in accordance with the current movement trajectory on the basis of the estimation result. In another technique (Non-Patent Literature 2), a past movement trajectory of a user is modeled using a long short-term memory (LSTM), and a destination is predicted in accordance with the current movement trajectory. Moreover, in a technique (Non-Patent Literature 3), movement trajectories of all users are learned as a whole.

In the above techniques, since the past movement trajectory data of the user is used, it is difficult to predict the destination of the user whose movement trajectory data in the past does not exist and the destination of the user who is moving to a place that the user has not visited before. In the technique in which the movement trajectory data of all the users is learned as a whole, the movement trajectory data corresponds to personal information regarding privacy. Thus, predicting the destination of a particular user by using the movement trajectory data of the other users is not allowed in many cases, and this technique cannot necessarily be used.

However, there are many cases where it is desired to predict the destination in a situation where the movement trajectory data does not exist, for example, in the movement at a place that the user visits for the first time, such as a tourist site, the movement of the user who has recently started to use the service, or the like. On the other hand, there is movement tendency data as data that can predict the destination of the user whose movement trajectory data does not exist.

In a case where a space is sectioned into areas, the movement tendency data is data in which the number of users who moved from a first area to a second area between first time and second time is recorded. For example, the movement tendency data is data indicating that the number of people who moved from the periphery of Yokohama station to the periphery of Tokyo station between 9:00 and 10:00 is x, the number of people who moved from the periphery of Yokohama station to the periphery of Shinagawa station between 9:00 and 10:00 is y, or the like.

### CITATION LIST

### Non-Patent Literature

Non-Patent Literature 1: Yoshiaki Takimoto, Kyosuke Nishida, Yuki Endo, Hiroyuki Toda, Hiroshi Sawada, Yoshiharu Ishikawa, “Personalized Destination Prediction Considering Time Zone”, IEICE Transactions, Vol. J100-D, No. 4, 2017, pp. 472-484
Non-Patent Literature 2: Yuki Endo, Kyosuke Nishida, Hiroyuki Toda, Hiroshi Sawada, “Predicting Destinations from Partial Trajectories Using Recurrent Neural Network”, [online], [searched on February 6, H31], Internet (URL: http://www.npal.cs.tsukuba.ac.jp/˜endo/pdf/pakdd2017_endo_preprint.pdf)
Non-Patent Literature 3: Andy Yuan Xue et al., “Destination Prediction by Sub-Trajectory Synthesis and Privacy Protection Against Such Prediction”, ICDE '13 Proceedings of the 2013 IEEE International Conference on Data Engineering (ICDE 2013), 2013, pp. 254-265
Non-Patent Literature 4: Yasunori Akagi, Takuya Nishimura, Takeshi Kurashima, Hiroyuki Toda, “A Fast and Accurate Method for Estimating People Flow from Spatiotemporal Population Data”, Proceedings of the Twenty-Seventh International Joint Conference on Artificial Intelligence (IJCAI-18), 2018, pp. 3293-3300

### SUMMARY OF THE INVENTION

### Technical Problem

The movement tendency data has fewer problems in privacy than the movement trajectory data corresponding to the personal information. Thus, the movement tendency data has been used widely. Moreover, in a technique (Non-Patent Literature 4), a destination is also estimated on the basis of a population distribution in each area in each time. A problem with the destination prediction using this technique is that while it allows the movement prediction for the user whose movement trajectory data in the past does not exist, the accuracy of the movement prediction for the user whose movement trajectory data in the past exists is lower than that of the prediction based on the past movement trajectory data.

An object of the present disclosure is to predict a destination of a user with high accuracy while the user is moving regardless of whether past movement trajectory data of the user does not exist or the past movement trajectory data of the user exists.

### Means for Solving the Problem

A destination prediction device according to a first aspect of the present disclosure includes: a first destination prediction unit that predicts a destination candidate of a user who is moving and a value that represents certainty of the destination candidate on the basis of movement trajectory data that represents a movement trajectory of the user to a present point and movement history data of the user in a past; a second destination prediction unit that predicts a destination candidate of the user and a value that represents the certainty of the destination candidate on the basis of the movement trajectory data of the user and data that represents a movement tendency set in accordance with movement states of people; and an ensemble prediction unit that predicts a destination and a value that represents the certainty of the destination by combining the destination candidate and the value that represents the certainty of the destination candidate predicted by the first destination prediction unit and the destination candidate and the value that represents the certainty of the destination candidate predicted by the second destination prediction unit.

A second aspect of the present disclosure is the destination prediction device according to the first aspect, wherein the first destination prediction unit predicts the value that represents the certainty of the destination candidate using a confidence of the prediction by the first destination prediction unit and probability that the destination candidate predicted by the first destination prediction unit is the destination.

A third aspect of the present disclosure is the destination prediction device according to the first or second aspect, wherein the second destination prediction unit predicts the value that represents the certainty of the destination candidate using a confidence of the prediction by the second destination prediction unit and probability that the destination candidate predicted by the second destination prediction unit is the destination.

A fourth aspect of the present disclosure is the destination prediction device according to any one of the first to third aspects, wherein the destination prediction device further includes a presentation unit that presents the destination and the value that represents the certainty that the destination is the destination that are predicted by the ensemble prediction unit, to a display device.

A fifth aspect of the present disclosure is the destination prediction device according to the fourth aspect, wherein the presentation unit further presents a contribution ratio of the value representing the certainty that the destination candidate predicted by the first destination prediction unit is the destination and a contribution ratio of the value representing the certainty that the destination candidate predicted by the second destination prediction unit is the destination with respect to the value representing the certainty that the destination predicted by the ensemble prediction unit is the destination, to the display device.

A sixth aspect of the present disclosure is a destination prediction method, wherein a computer performs: predicting a destination candidate of a user who is moving and a value that represents certainty of the destination candidate on the basis of movement trajectory data that represents a movement trajectory of the user to a present point and movement history data of the user in a past; predicting a destination candidate of the user and a value that represents the certainty of the destination candidate on the basis of the movement trajectory data of the user and data that represents a movement tendency set in accordance with movement states of people; and predicting a destination and a value that represents the certainty of the destination by combining the destination candidate and the value that represents the certainty of the destination candidate of the prediction based on the movement trajectory data of the user and the movement history data of the user in the past, and the destination candidate and the value that represents the certainty of the destination candidate of the prediction based on the movement trajectory data of the user and the data that represents the movement tendency of the people.

A seventh aspect of the present disclosure is a program that causes a computer to perform a destination prediction process including: predicting a destination candidate of a user who is moving and a value that represents certainty of the destination candidate on the basis of movement trajectory data that represents a movement trajectory of the user to a present point and movement history data of the user in a past; predicting destination candidate of the user and a value that represents the certainty of the destination candidate on the basis of the movement trajectory data of the user and data that represents a movement tendency set in accordance with movement states of people; and predicting destination and a value that represents the certainty of the destination by combining the destination candidate and the value that represents the certainty of the destination candidate of the prediction based on the movement trajectory data of the user and the movement history data of the user in the past, and the destination candidate and the value that represents the certainty of the destination candidate of the prediction based on the movement trajectory data of the user and the data that represents the movement tendency of the people.

### Effects of the Invention

According to the present disclosure, it is possible to predict the destination of the user with high accuracy while the user is moving regardless of whether the past movement trajectory data of the user does not exist or the past movement trajectory data of the user exists. Thus, it is possible to predict the destination of any moving user as appropriate. For example, a service that presents information about the periphery of the destination before the user arrives at the destination on the basis of this prediction can be provided.

### BRIEF DESCRIPTION OF DRAWINGS

FIG. 1 is an exemplary functional structure diagram of a destination prediction device according to the present embodiment.

FIG. 2 is a schematic diagram of one example of transmission data of a query movement trajectory transmission unit according to the present embodiment.

FIG. 3A is a schematic diagram of one example of destination prediction result data of a personal history-based destination prediction unit according to the present embodiment.

FIG. 3B is a schematic diagram of one example of prediction situation data of the personal history-based destination prediction unit according to the present embodiment.

FIG. 4 is a schematic diagram of one example of accumulated data of a personal movement tendency model accumulation unit according to the present embodiment.

FIG. 5 is a schematic diagram of one example of a personal history-based prediction confidence that is calculated by a personal history-based prediction confidence calculation unit according to the present embodiment.

FIG. 6 is a schematic diagram of one example of accumulated data of a personal history-based prediction confidence model accumulation unit according to the present embodiment.

FIG. 7 is a schematic diagram of one example of a score of a personal history-based prediction score addition unit according to the present embodiment.

FIG. 8A is a schematic diagram of one example of destination prediction result data of a movement tendency-based destination prediction unit according to the present embodiment.

FIG. 8B is a schematic diagram of one example of prediction situation data of the movement tendency-based destination prediction unit according to the present embodiment.

FIG. 9 is a schematic diagram of one example of accumulated data of a movement tendency data accumulation unit according to the present embodiment.

FIG. 10 is a schematic diagram of one example of a movement tendency-based prediction confidence that is calculated by a movement tendency-based prediction confidence calculation unit according to the present embodiment.

FIG. 11 is a schematic diagram of one example of accumulated data of a movement tendency-based prediction confidence model accumulation unit according to the present embodiment.

FIG. 12 is a schematic diagram of one example of a score of a movement tendency-based prediction score addition unit according to the present embodiment.

FIG. 13 is a schematic diagram of one example of destination prediction result data of an ensemble prediction unit according to the present embodiment.

FIG. 14 is a schematic diagram of one example of accumulated data of an ensemble weight accumulation unit according to the present embodiment.

FIG. 15 is a schematic diagram of an exemplary screen of a display device that displays a prediction result that is visualized in a presentation unit according to the present embodiment.

FIG. 16 is one example of a hardware structure diagram of the destination prediction device according to the present embodiment.

FIG. 17 is an exemplary schematic diagram of the outline of a destination prediction process that is performed in the present embodiment.

FIG. 18 is an exemplary flowchart of the destination prediction process in the present embodiment.

### DESCRIPTION OF EMBODIMENTS

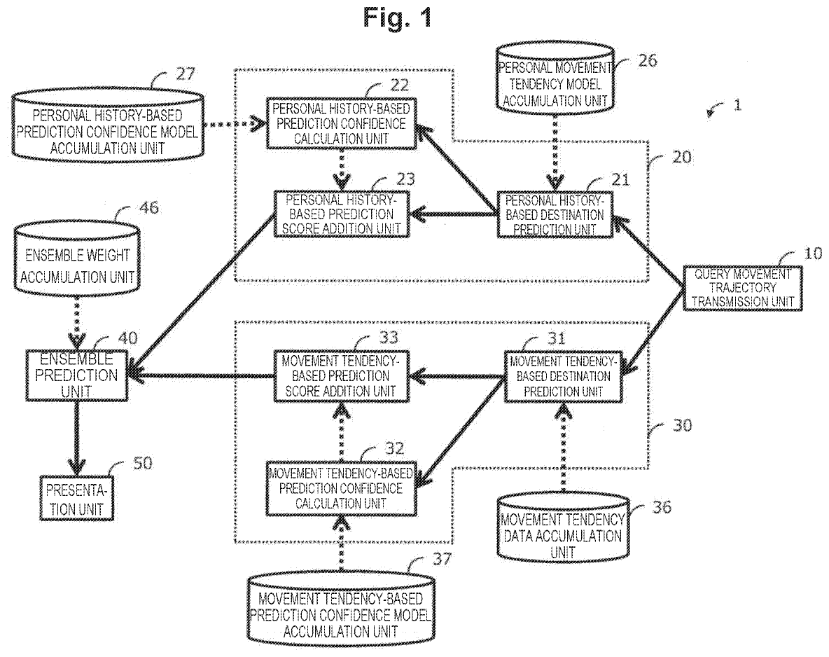

FIG. 1 illustrates one example of a functional structure diagram of a destination prediction device 1 according to the present embodiment. The destination prediction device 1 includes a query movement trajectory transmission unit 10, a first destination prediction unit 20, a second destination prediction unit 30, an ensemble prediction unit 40, and a presentation unit 50. The destination prediction device 1 also includes a personal movement tendency model accumulation unit 26, a personal history-based prediction confidence model accumulation unit 27, a movement tendency data accumulation unit 36, a movement tendency-based prediction confidence model accumulation unit 37, and an ensemble weight accumulation unit 46.

The first destination prediction unit 20 includes a personal history-based destination prediction unit 21, a personal history-based prediction confidence calculation unit 22, and a personal history-based prediction score addition unit 23. The second destination prediction unit 30 includes a movement tendency-based destination prediction unit 31, a movement tendency-based prediction confidence calculation unit 32, and a movement tendency-based prediction score addition unit 33.

In FIG. 1, a solid line arrow represents a flow of control, and a dotted line arrow represents a flow of data.

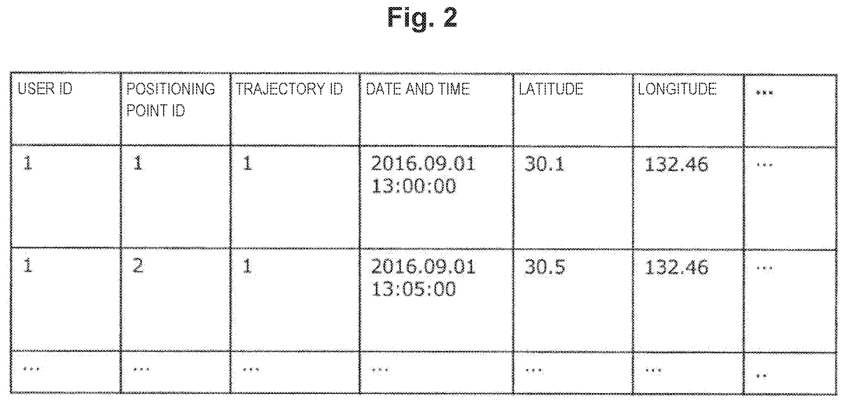

The query movement trajectory transmission unit 10 starts a destination prediction process by transmitting movement trajectory data of a user who is currently moving as a query of a destination prediction. FIG. 2 illustrates one example of the movement trajectory data that is transmitted from the query movement trajectory transmission unit 10. For example, the movement trajectory data includes data such as a user ID, a positioning point ID, a trajectory ID, date and time, latitude, and longitude.

The first destination prediction unit 20 performs a personal history-based destination prediction process. The personal history-based destination prediction unit 21 inputs, as a query, the movement trajectory data of the moving user transmitted from the query movement trajectory transmission unit 10, and reads out a movement tendency model of the user who is a prediction target from the personal movement tendency model accumulation unit 26. The personal history-based destination prediction unit 21 performs the destination prediction on the basis of the movement trajectory data of the moving user and the movement tendency model of the user, and obtains destination prediction result data and prediction situation data.

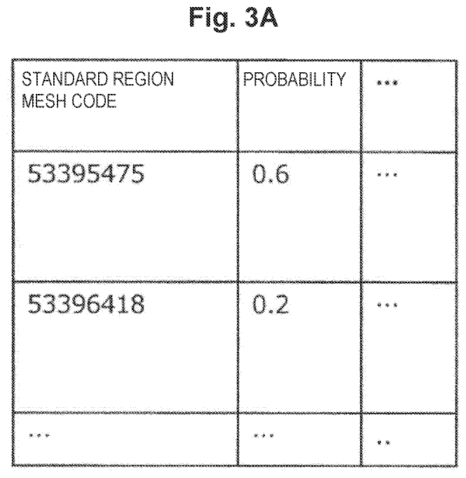

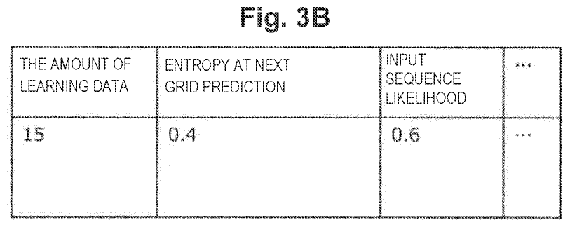

FIG. 3A illustrates one example of the destination prediction result data, and FIG. 3B illustrates one example of the prediction situation data. The example of the destination prediction result data illustrated in FIG. 3A includes a standard region mesh code and probability. The standard region mesh code represents an area of a destination candidate of the prediction result. Standard region mesh is mesh defined by Ministry of Internal Affairs and Communications. In the standard region mesh, regions are divided in an approximately square shape on the basis of the latitude and the longitude. The standard region mesh code is a code that identifies the mesh.

The area according to the present embodiment is not limited to the standard region mesh. The area may be a rectangle whose four corners are represented by the latitude and the longitude, or an area specified by a code mark, for example, Geohash. The area of the destination candidate of the prediction result may be either one or plural.

The prediction process in the personal history-based destination prediction unit 21 can be achieved by using existing techniques (for example, Non-Patent Literature 2) or the like. In the existing techniques, the prediction process is performed as follows, for example.

(1) To LSTM having learned the past movement trajectory data of the target user, a sequence of grids from the departure time to the current time is input, and probability distribution that represents the grid where the user exists at the next time is predicted.
(2) In accordance with the predicted probability distribution, the next grid is sampled, the obtained grid is input to the LSTM, and the grid following the next grid is predicted.
(3) (2) is repeated until the user reaches the grid that the user visited in the past (destination candidate).
(4) (2) and (3) are repeated a sufficient number of times, and a value that is obtained by dividing the number of times of reaching by the number of times of trials is regarded as the probability that each destination candidate is the destination.

That is to say, the probability of the destination prediction result data may be the probability that each area in a geographical space is the destination. The prediction situation data is data that is used by the personal history-based prediction confidence calculation unit 22 to estimate a confidence of the personal history-based destination prediction in the first destination prediction unit 20. The prediction situation data includes, for example, the amount of learning data, entropy at the next grid prediction, and input sequence likelihood. The amount of the learning data is the amount of the movement trajectory data that is learned when the movement tendency model of the user who is the prediction target is learned. The entropy at the next grid prediction is entropy of the probability distribution when the next grid is sampled in the prediction in which the existing techniques are used. The entropy at the next grid prediction may be an average value of the entropy in the entire samplings, for example.

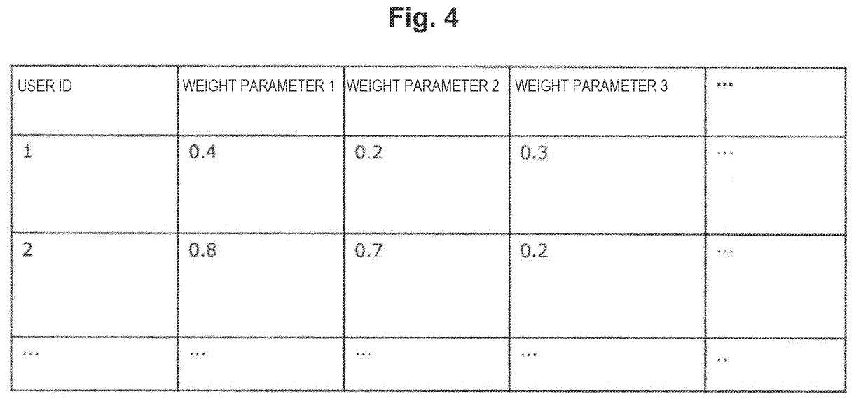

The personal movement tendency model accumulation unit 26 accumulates parameters of the model that is used when the prediction process in the personal history-based destination prediction unit 21 is performed. If the prediction is performed using the existing techniques (for example, Non-Patent Literature 2), for example, the parameters may be weight parameters in the LSTM. FIG. 4 illustrates one example of accumulated data in the personal movement tendency model accumulation unit 26. For example, this accumulated data includes the user ID and a plurality of weight parameters in the LSTM corresponding to the user ID.

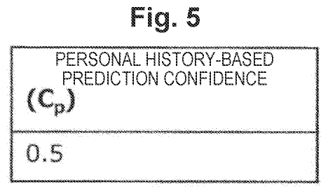

The personal history-based prediction confidence calculation unit 22 receives the prediction situation data from the personal history-based destination prediction unit 21, reads out an estimation model of the prediction confidence from the personal history-based prediction confidence model accumulation unit 27, estimates the confidence of the personal history-based destination prediction on the basis of the prediction situation data and the estimation model of the prediction confidence, and outputs a personal history-based prediction confidence Cp. FIG. 5 illustrates one example of the personal history-based prediction confidence Cp. The higher value of the prediction confidence indicates the learning is performed more sufficiently and the reliability of the prediction is higher.

As the estimation model of the prediction confidence, a regression model such as a linear regression model or a regression random forest model may be used.

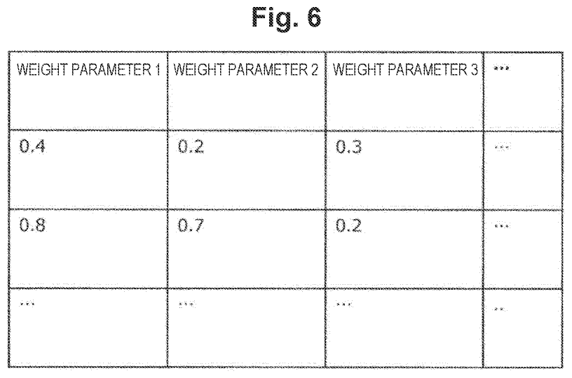

The personal history-based prediction confidence model accumulation unit 27 stores parameters of the estimation model when the personal history-based prediction confidence calculation unit 22 calculates the prediction confidence on the basis of the prediction situation data. If the linear regression model is used as the estimation model of the prediction confidence, the parameters may be weight parameters in the linear regression model, for example. The parameters that are accumulated in the personal history-based prediction confidence model accumulation unit 27 illustrated in FIG. 6 may be a plurality of weight parameters in the linear regression model, for example.

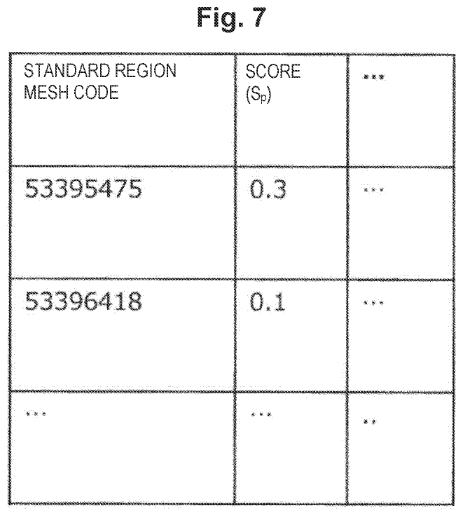

The personal history-based prediction score addition unit 23 adds a score to each area corresponding to one example of the destination candidate on the basis of the prediction situation data that is output from the personal history-based destination prediction unit 21 and the prediction confidence calculated by the personal history-based prediction confidence calculation unit 22. The score is one example of the value that represents the certainty. FIG. 7 illustrates one example of output data from the personal history-based prediction score addition unit 23. For example, this output data includes the standard region mesh code representing each area corresponding to one example of the destination candidate, and a score Sp.

For example, the score may be obtained by multiplying the probability that each area that is output from the personal history-based destination prediction unit 21 is the destination and the prediction confidence that is output from the personal history-based prediction confidence calculation unit 22.

For example, a score Sp(j) of an area j is calculated by using Expression (1):

Sp(j)=CpPp(j) (1)

where, Pp(j) represents the probability that the area j output from the personal history-based destination prediction unit 21 is the destination, and Cp represents the prediction confidence output from the personal history-based prediction confidence calculation unit 22.

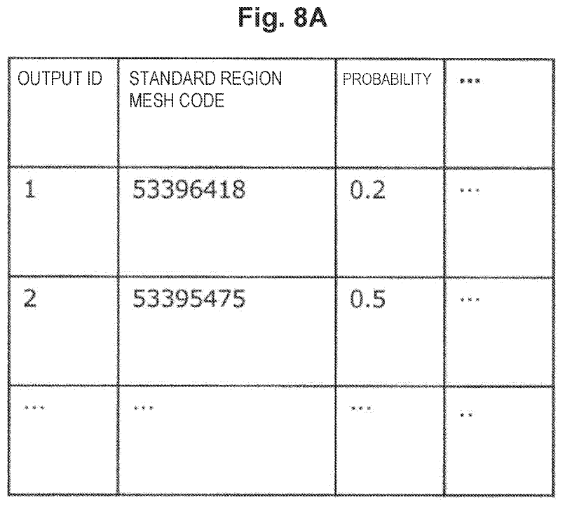

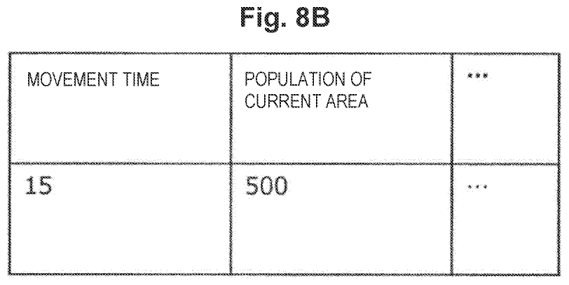

The second destination prediction unit 30 performs a movement tendency-based destination prediction process. The movement tendency-based destination prediction unit 31 inputs, as a query, the movement trajectory data of the moving user transmitted from the query movement trajectory transmission unit 10, reads out movement tendency data from the movement tendency data accumulation unit 36, and performs the destination prediction on the basis of the movement trajectory data of the moving user and the movement tendency data. Then, the movement tendency-based destination prediction unit 31 outputs the destination prediction result data representing the result of the destination prediction and the prediction situation data. FIG. 8A illustrates one example of the destination prediction result data, and FIG. 8B illustrates one example of the prediction situation data.

For example, the destination prediction result data includes an output ID, the standard region mesh code representing the area of the destination candidate, and the probability. The area of the destination candidate of the prediction result may be either one or plural. In detail, for example, probability Pg(j) that the area where the user currently exists is an area i and the area j is the destination is calculated by using Expression (2):

$$\begin{matrix}[ Math . 1 ] & \\ {P}_{g} ( j ) = \frac{{M}_{ij}}{{\sum }_{k ∈ A} {M}_{ik}} & ( 2 )\end{matrix}$$

where, A represents a set of all areas and Mᵢₖ represents the number of people who moves from the area i to an area k in a target time zone that is included in the movement tendency data. Mᵢⱼ represents the number of people who moves from the area i to the area j in the target time zone that is included in the movement tendency data. For example, the prediction situation data includes the movement time length of the moving user that is input, the population of the area where the user currently exists, and the like.

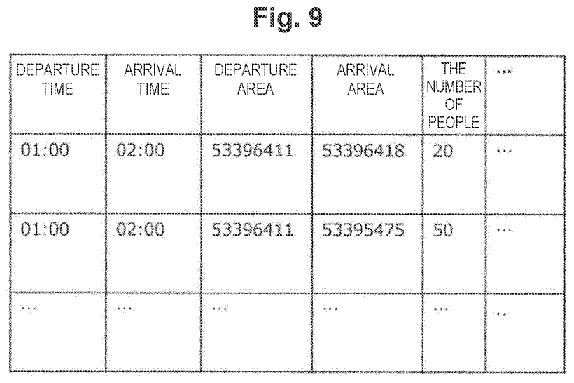

The movement tendency data accumulation unit 36 accumulates the movement tendency data. As exemplary illustrated in FIG. 9, the movement tendency data includes departure time and arrival time representing the time zone, two area IDs of a departure area and an arrival area, and the number of people who moves between the two areas in this time zone. The movement tendency data may be the actual movement tendency data that is obtained by GPS or the like, data that is obtained by the estimation with the existing methods (for example, Non-Patent Literature 4) from population distribution information, or the like.

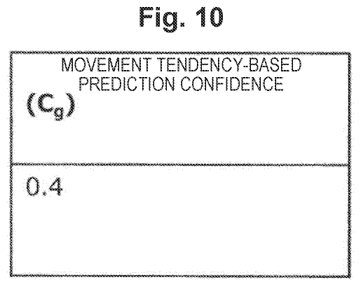

The movement tendency-based prediction confidence calculation unit 32 inputs the prediction situation data from the movement tendency-based destination prediction unit 31, reads out an estimation model of the prediction confidence from the movement tendency-based prediction confidence model accumulation unit 37, estimates the confidence of the movement tendency-based destination prediction on the basis of the prediction situation data and the estimation model, and outputs movement tendency-based prediction confidence Cg as the estimated value. FIG. 10 illustrates one example of the movement tendency-based prediction confidence Cg.

For example, the estimation model of the prediction confidence may be a regression model such as a linear regression model or a regression random forest model.

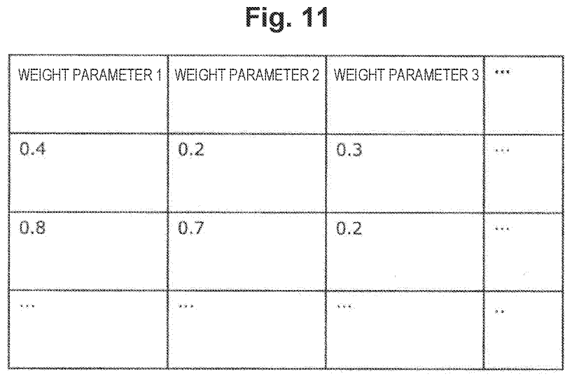

The movement tendency-based prediction confidence model accumulation unit 37 accumulates parameters of the estimation model when the movement tendency-based prediction confidence calculation unit 32 calculates the movement tendency-based prediction confidence on the basis of the prediction situation data. If the linear regression model is used as the estimation model of the prediction confidence, the parameters of the estimation model may be weight parameters in the linear regression model. The accumulated data in the movement tendency-based prediction confidence model accumulation unit 37 exemplary illustrated in FIG. 11 includes a plurality of weight parameters in the linear regression model.

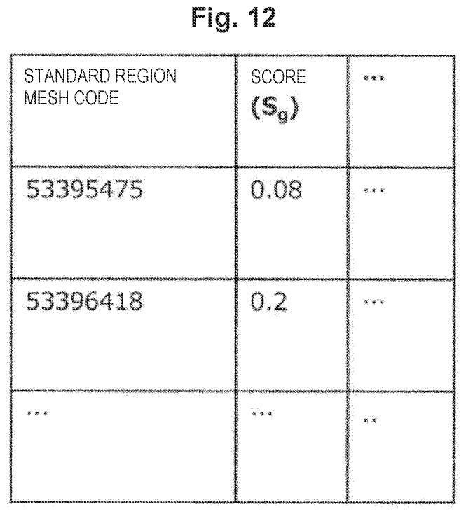

The movement tendency-based prediction score addition unit 33 outputs a score of each area corresponding to one example of the destination candidate on the basis of the prediction situation data that is output from the movement tendency-based destination prediction unit 31 and the prediction confidence that is output from the movement tendency-based prediction confidence calculation unit 32. The score is one example of the value that represents the certainty. Output data from the movement tendency-based prediction score addition unit 33 exemplary illustrated in FIG. 12 includes, for example, the standard region mesh code representing each area corresponding to one example of the destination candidate, and a score Sg.

For example, the movement tendency-based prediction score addition unit 33 may set, as the score Sg, the score obtained by multiplying the probability that each area is the destination, the probability being input from the movement tendency-based destination prediction unit 31, and the prediction confidence that is input from the movement tendency-based prediction confidence calculation unit 32.

For example, a score Sg(j) of the area j is calculated by using Expression (3):

Sg(j)=CgPg(j) (3)

where, Pg(j) represents the probability that the area j is the destination, the probability being input from the movement tendency-based destination prediction unit 31, and Cg represents the prediction confidence that is input from the movement tendency-based prediction confidence calculation unit 32.

The ensemble prediction unit 40 inputs the destination candidate predicted by the personal history-based prediction and the personal history-based prediction score of the destination candidate from the personal history-based prediction score addition unit 23. The ensemble prediction unit 40 inputs the destination candidate predicted by the movement tendency-based prediction and the movement tendency-based prediction score of the destination candidate from the movement tendency-based prediction score addition unit 33. In addition, the ensemble prediction unit 40 reads out weight parameters from the ensemble weight accumulation unit 46.

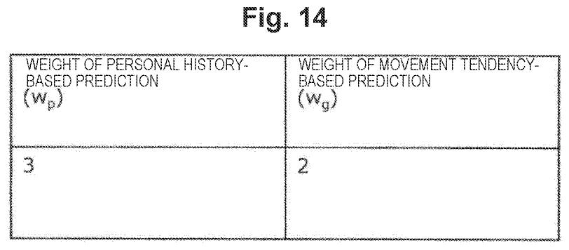

The ensemble weight accumulation unit 46 stores the weight used when the ensemble prediction unit 40 performs ensemble prediction. FIG. 14 illustrates weight wp of the personal history-based prediction and weight wg of the movement tendency-based prediction each corresponding to one example of the accumulated data in the ensemble weight accumulation unit 46.

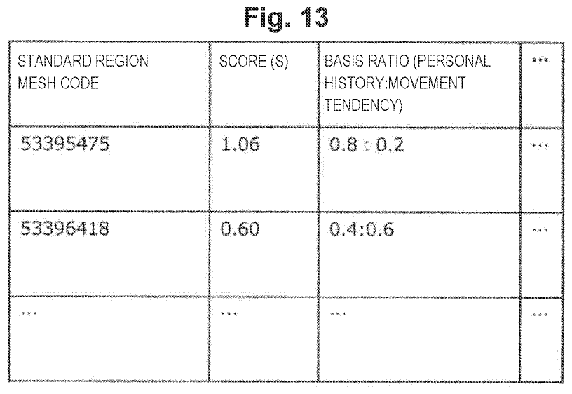

The ensemble prediction unit 40 predicts an ensemble score in each area corresponding to one example of the destination by using the personal history-based prediction score, the movement tendency-based prediction score, and the weight, and outputs the basis ratio of the ensemble score prediction. The ensemble score is one example of the value that represents the certainty of the destination. FIG. 13 illustrates one example of output data from the ensemble prediction unit 40. For example, the output data includes the standard region mesh code representing the area of the destination, an ensemble score S, and the basis ratio corresponding to the contribution ratio of the personal history-based prediction and the contribution ratio of the movement tendency-based prediction with respect to the ensemble score prediction. The area of the destination of the prediction result may be either one or plural.

For example, an ensemble score S(j) of the area j is calculated by using Expression (4):

S(j)=wpSp(j)+wgSg(j)+ (4)

where, Sp(j) represents the score of the area j that is added by the personal history-based prediction score addition unit 23, Sg(j) represents the score of the area j that is added by the movement tendency-based prediction score addition unit 33, and wp and wg represent the weight parameters read out from the ensemble weight accumulation unit 46.

For example, the contribution ratio of the personal history-based prediction with respect to the ensemble score prediction may be wpSp(j) and the contribution ratio of the movement tendency-based prediction with respect to the ensemble score prediction may be wgSg(j). That is to say, the basis ratio may be wgSg(j):wpSp(j).

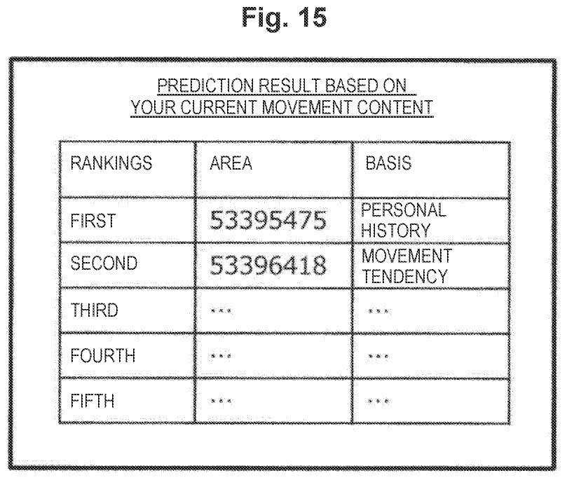

The presentation unit 50 visualizes the output from the ensemble prediction unit 40 and causes a display device to display this output. FIG. 15 illustrates one example of a screen that displays the visualized output from the ensemble prediction unit 40. For example, the presentation unit 50 outputs the rankings in which the areas corresponding to the destinations are arranged in descending order from the highest ensemble score. Moreover, the presentation unit 50 may visualize the output and display whether the ensemble score is mainly based on the personal history-based prediction or the movement tendency-based prediction.

For example, if the value of wgSg(j) is larger than the value of wpSp(j) in Expression (4), it is displayed that the ensemble score is mainly based on the movement tendency-based prediction. On the other hand, if the value of wpSp(j) is larger than the value of wgSg(j), it is displayed that the ensemble score is mainly based on the personal history-based prediction. Note that the presentation unit 50 may visualize the basis ratio exemplary illustrated in FIG. 13 and cause the display device to display the visualized basis ratio.

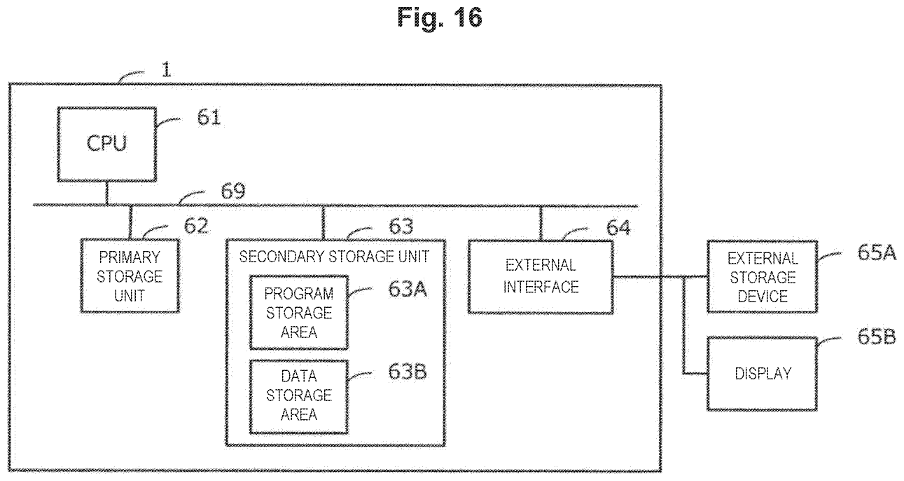

FIG. 16 illustrates one example of a hardware structure of the destination prediction device 1. As illustrated in FIG. 16, the destination prediction device 1 includes, for example, a CPU (Central Processing Unit) 61, a primary storage unit 62, a secondary storage unit 63, and an external interface 64. The CPU 61 is one example of a processor corresponding to hardware. The CPU 61, the primary storage unit 62, the secondary storage unit 63, and the external interface 64 are connected to each other through a bus 69.

For example, the primary storage unit 62 is a volatile memory such as a RAM (Random Access Memory). For example, the secondary storage unit 63 is a non-volatile memory such as an HDD (Hard Disk Drive) or an SSD (Solid State Drive).

The secondary storage unit 63 includes a program storage area 63A and a data storage area 63B. The program storage area 63A stores, for example, programs such as a destination prediction program. For example, the data storage area 63B functions as the personal movement tendency model accumulation unit 26, the personal history-based prediction confidence model accumulation unit 27, the movement tendency data accumulation unit 36, the movement tendency-based prediction confidence model accumulation unit 37, and the ensemble weight accumulation unit 46.

The CPU 61 reads out the destination prediction program from the program storage area 63A, and develops the program on the primary storage unit 62. The CPU 61 loads and executes the destination prediction program so as to operate as the query movement trajectory transmission unit 10, the personal history-based destination prediction unit 21, the personal history-based prediction confidence calculation unit 22, the personal history-based prediction score addition unit 23, the movement tendency-based destination prediction unit 31, the movement tendency-based prediction confidence calculation unit 32, the movement tendency-based prediction score addition unit 33, the ensemble prediction unit 40, and the presentation unit 50 in FIG. 1.

Note that the programs including the destination prediction program may be stored in an external server, and developed on the primary storage unit 62 through a network. Moreover, the programs including the destination prediction program may be stored in a non-transitory recording medium such as a digital versatile disc (DVD), and developed on the primary storage unit 62 through a recording medium reading device.

To the external interface 64, an external device is connected and the external interface 64 controls transmission and reception of various pieces of information between the external device and the CPU 61. FIG. 16 illustrates one example in which an external storage device 65A and a display 65B are connected to the external interface 64.

The prediction result of the ensemble prediction exemplary illustrated in FIG. 13 may be recorded in the external storage device 65A, or displayed on the screen of the display 65B, as exemplary illustrated in FIG. 15, in characters or images. The external storage device 65A and the display 65B do not need to be connected to the external interface 64, and any one of them may be connected to the external interface 64. Moreover, one of or both the external storage device 65A and the display 65B may be housed in the destination prediction device 1, or disposed at the position away from the destination prediction device 1 through the network.

Furthermore, the destination prediction device 1 may be a dedicated device, or a general-purpose device such as a workstation, a personal computer, or a tablet.

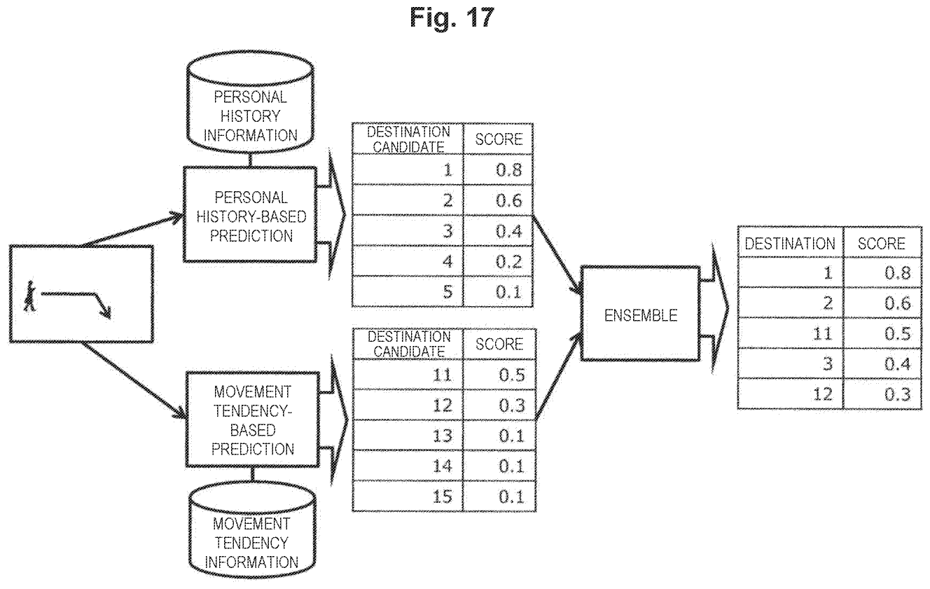

FIG. 17 illustrates one example of a schematic diagram that explains the outline of the destination prediction process according to the present embodiment. The query movement trajectory transmission unit 10 inputs the movement trajectory data of the moving user as the query. The first destination prediction unit 20 performs the personal history-based prediction using the movement trajectory data of the moving user and the personal history information including the accumulated data in the personal movement tendency model accumulation unit 26 and the personal history-based prediction confidence model accumulation unit 27, and outputs the destination candidate and the score of the destination candidate.

The second destination prediction unit 30 performs the movement tendency-based prediction using the movement trajectory data of the moving user and the movement tendency information including the accumulated data in the movement tendency data accumulation unit 36 and the movement tendency-based prediction confidence model accumulation unit 37, and outputs the destination candidate and the score of the destination candidate. The ensemble prediction unit 40 predicts the destination and the score of the destination using the destination candidate and the score of the destination candidate predicted by the first destination prediction unit 20, and the destination candidate and the score of the destination candidate predicted by the second destination prediction unit 30.

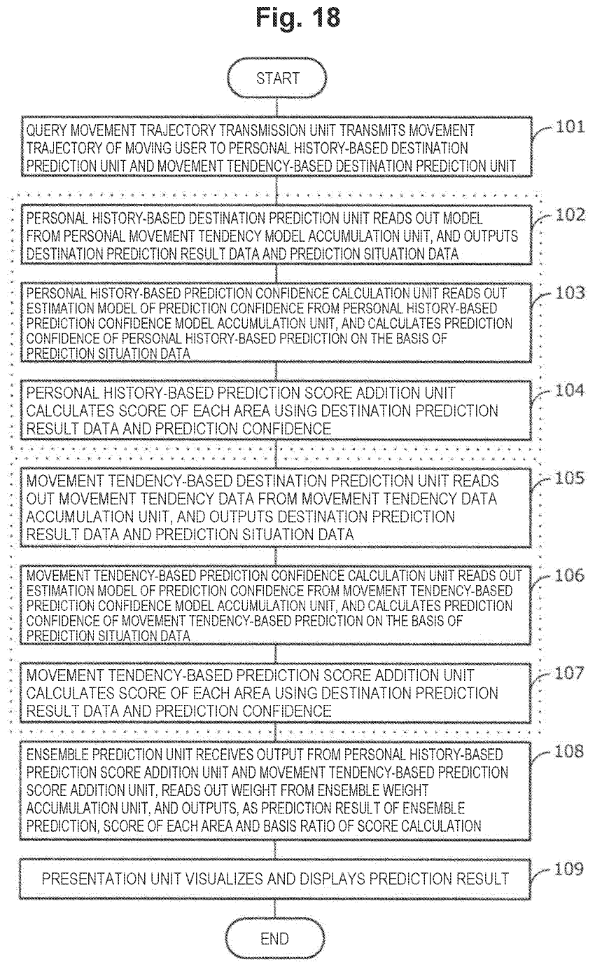

FIG. 18 illustrates a flow of the destination prediction process according to the present embodiment. In step 101, the query movement trajectory transmission unit 10 transmits the movement trajectory data of the moving user to the personal history-based destination prediction unit 21 and the movement tendency-based destination prediction unit 31. In step 102, the personal history-based destination prediction unit 21 reads out the model from the personal movement tendency model accumulation unit 26, and outputs the destination prediction result data and the prediction situation data.

In step 103, the personal history-based prediction confidence calculation unit 22 reads out the estimation model of the prediction confidence from the personal history-based prediction confidence model accumulation unit 27, and calculates the confidence of the personal history-based prediction of the first destination prediction unit 20 on the basis of the estimation model and the prediction situation data. In step 104, the personal history-based prediction score addition unit 23 calculates the score of each area of the destination candidates using the destination prediction result data and the prediction confidence.

In step 105, the movement tendency-based destination prediction unit 31 reads out the movement tendency data from the movement tendency data accumulation unit 36, and outputs the destination prediction result data and the prediction situation data. In step 106, the movement tendency-based prediction confidence calculation unit 32 reads out the estimation model of the prediction confidence from the movement tendency-based prediction confidence model accumulation unit 37, and calculates the confidence of the movement tendency-based prediction of the second destination prediction unit 30 on the basis of the estimation model and the prediction situation data.

In step 107, the movement tendency-based prediction score addition unit 33 calculates the score of each area of the destination candidates using the destination prediction result data and the prediction confidence. In step 108, the ensemble prediction unit 40 receives the prediction result of the personal history-based prediction from the first destination prediction unit 20 and the prediction result of the movement tendency-based prediction from the second destination prediction unit 30. The ensemble prediction unit 40 reads out the weight of the personal history-based prediction and the weight of the movement tendency-based prediction from the ensemble weight accumulation unit 46, and outputs, as the prediction result of the ensemble prediction, each area of the destination, the score of each area, and the basis ratio of the score calculation.

In step 109, the presentation unit 50 visualizes the prediction result of the ensemble prediction, and causes the display 65B to display the visualized prediction result as exemplary illustrated in FIG. 15, for example. Then, the destination prediction process ends. Note that the flowchart in FIG. 18 is one example, and the order of the process may be changed as appropriate.

The present embodiment includes the first destination prediction unit, the second destination prediction unit, and the ensemble prediction unit. The first destination prediction unit predicts the destination candidate of the user who is moving and the value that represents the certainty of the destination candidate on the basis of the movement trajectory data that represents the movement trajectory of the user to the present point and the movement history data of the user in the past. The second destination prediction unit predicts the destination candidate of the user and the value that represents the certainty of the destination candidate on the basis of the movement trajectory data of the user and the data that represents the movement tendency set in accordance with the movement states of the people. The ensemble prediction unit predicts the destination and the value that represents the certainty of the destination by combining the destination candidate and the value that represents the certainty of the destination candidate predicted by the first destination prediction unit and the destination candidate and the value that represents the certainty of the destination candidate predicted by the second destination prediction unit.

Thus, it is possible to predict the destination of the user with high accuracy while the user is moving regardless of whether the past movement trajectory data of the user does not exist or the past movement trajectory data of the user exists. Therefore, in the present embodiment, it is possible to predict the destination of any moving user as appropriate regardless of the amount of the past movement trajectory data. For example, the service that presents the information about the periphery of the destination before the user arrives at the destination on the basis of this prediction can be provided.

1. A destination prediction device comprising:
a first destination predictor configured to predict a destination candidate of a user who is moving and a value that represents certainty of the destination candidate on the basis of movement trajectory data that represents a movement trajectory of the user to a present point and movement history data of the user in a past;
a second destination predictor configured to predict a destination candidate of the user and a value that represents the certainty of the destination candidate on the basis of the movement trajectory data of the user and data that represents a movement tendency set in accordance with movement states of people; and
an ensemble predictor configured to predict a destination and a value that represents the certainty of the destination by combining at least:
the destination candidate and the value that represents the certainty of the destination candidate predicted by the first destination predictor, and
the destination candidate and the value that represents the certainty of the destination candidate predicted by the second destination predictor.

2. The destination prediction device according to claim 1, wherein the first destination predictor predicts the value that represents the certainty of the destination candidate using a confidence of the prediction by the first destination predictor and probability that the destination candidate predicted by the first destination predictor is the destination.

3. The destination prediction device according to claim 1, wherein the second destination predictor the value that represents the certainty of the destination candidate using a confidence of the prediction by the second destination predictor and probability that the destination candidate predicted by the second destination predictor is the destination.

4. The destination prediction device according to claim 1, further comprising:
a presenter configured to present the destination candidate and the value that represents the certainty that the destination candidate is the destination that are predicted by the ensemble predictor, to a display device.

5. The destination prediction device according to claim 4, wherein the presenter further presents a contribution ratio of the value representing the certainty that the destination candidate predicted by the first destination predictor is the destination and a contribution ratio of the value representing the certainty that the destination candidate predicted by the second destination predictor is the destination with respect to the value representing the certainty that the destination predicted by the ensemble is the destination, to the display device.

6. A destination prediction method, the method comprising:
predicting, by a first destination predictor, a destination candidate of a user who is moving and a value that represents certainty of the destination candidate on the basis of movement trajectory data that represents a movement trajectory of the user to a present point and movement history data of the user in a past;
predicting, by a second destination predictor, a destination candidate of the user and a value that represents the certainty of the destination candidate on the basis of the movement trajectory data of the user and data that represents a movement tendency set in accordance with movement states of people; and
predicting, by an ensemble predictor, a destination and a value that represents the certainty of the destination by combining at least:
the destination candidate and the value that represents the certainty of the destination candidate of the prediction, predicted by the first destination predictor, based on the movement trajectory data of the user and the movement history data of the user in the past, and
the destination candidate and the value that represents the certainty of the destination candidate of the prediction, predicted by the second destination predictor, based on the movement trajectory data of the user and the data that represents the movement tendency of the people.

7. A computer-readable non-transitory recording medium storing a computer-executable program instructions that when executed by a processor cause a computer system to:
predict, by a first destination predictor, a destination candidate of a user who is moving and a value that represents certainty of the destination candidate on the basis of movement trajectory data that represents a movement trajectory of the user to a present point and movement history data of the user in a past;
predict, by a second destination predictor, a destination candidate of the user and a value that represents the certainty of the destination candidate on the basis of the movement trajectory data of the user and data that represents a movement tendency set in accordance with movement states of people; and
predict, by an ensemble predictor, a destination and a value that represents the certainty of the destination by combining at least:
the destination candidate and the value that represents the certainty of the destination candidate of the prediction, predicted by the first destination predictor, based on the movement trajectory data of the user and the movement history data of the user in the past, and
the destination candidate and the value that represents the certainty of the destination candidate of the prediction, predicted by the second destination predictor, based on the movement trajectory data of the user and the data that represents the movement tendency of the people.

8. The destination prediction device according to claim 2, wherein the second destination predictor the value that represents the certainty of the destination candidate using a confidence of the prediction by the second destination predictor and probability that the destination candidate predicted by the second destination predictor is the destination.

9. The destination prediction device according to claim 2, further comprising:
a presenter configured to present the destination candidate and the value that represents the certainty that the destination candidate is the destination that are predicted by the ensemble predictor, to a display device.

10. The destination prediction device according to claim 9, wherein the presenter further presents a contribution ratio of the value representing the certainty that the destination candidate predicted by the first destination predictor is the destination and a contribution ratio of the value representing the certainty that the destination candidate predicted by the second destination predictor is the destination with respect to the value representing the certainty that the destination predicted by the ensemble is the destination, to the display device.

11. The destination prediction device according to claim 3, further comprising:
a presenter configured to present the destination candidate and the value that represents the certainty that the destination candidate is the destination that are predicted by the ensemble predictor, to a display device.

12. The destination prediction device according to claim 11, wherein the presenter further presents a contribution ratio of the value representing the certainty that the destination candidate predicted by the first destination predictor is the destination and a contribution ratio of the value representing the certainty that the destination candidate predicted by the second destination predictor is the destination with respect to the value representing the certainty that the destination predicted by the ensemble is the destination, to the display device.

13. The method according to claim 6, wherein the first destination predictor predicts the value that represents the certainty of the destination candidate using a confidence of the prediction by the first destination predictor and probability that the destination candidate predicted by the first destination predictor is the destination.

14. The method according to claim 13, wherein the second destination predictor the value that represents the certainty of the destination candidate using a confidence of the prediction by the second destination predictor and probability that the destination candidate predicted by the second destination predictor is the destination.

15. The method according to claim 13, further comprising:
presenting, by a presenter, the destination candidate and the value that represents the certainty that the destination candidate is the destination that are predicted by the ensemble predictor, to a display device.

16. The method according to claim 15, wherein the presenter further presents a contribution ratio of the value representing the certainty that the destination candidate predicted by the first destination predictor is the destination and a contribution ratio of the value representing the certainty that the destination candidate predicted by the second destination predictor is the destination with respect to the value representing the certainty that the destination predicted by the ensemble is the destination, to the display device.

17. The computer-readable non-transitory recording medium of claim 7, wherein the second destination predictor the value that represents the certainty of the destination candidate using a confidence of the prediction by the second destination predictor and probability that the destination candidate predicted by the second destination predictor is the destination.

18. The computer-readable non-transitory recording medium of claim 17, wherein the second destination predictor the value that represents the certainty of the destination candidate using a confidence of the prediction by the second destination predictor and probability that the destination candidate predicted by the second destination predictor is the destination.

19. The computer-readable non-transitory recording medium of claim 17, the computer-executable instructions when executed further causing the system to:
present, by a presenter, the destination candidate and the value that represents the certainty that the destination candidate is the destination that are predicted by the ensemble predictor, to a display device.

20. The computer-readable non-transitory recording medium of claim 19, wherein the presenter further presents a contribution ratio of the value representing the certainty that the destination candidate predicted by the first destination predictor is the destination and a contribution ratio of the value representing the certainty that the destination candidate predicted by the second destination predictor is the destination with respect to the value representing the certainty that the destination predicted by the ensemble is the destination, to the display device.
